(19) United States
(12) Patent Application Publication
(10) Pub. No.: US 2024/0288713 A1
(43) Pub. Date: Aug. 29, 2024

(54) COLOR MASK FOR EMBEDDED CONTACT LENSES

(71) Applicant: Alcon Inc., Fribourg (CH)

(72) Inventors: Ethan Leveillee, Atlanta, GA (US); Joseph Michael Lindacher, Suwanee, GA (US); David Borja, Suwanee, GA (US); Ying Pi, Cumming, GA (US); Newton T. Samuel, Suwanee, GA (US); Ya-Wen Chang, Alpharetta, GA (US)

(21) Appl. No.: 18/588,279

(22) Filed: Feb. 27, 2024

Related U.S. Application Data
(60) Provisional application No. 63/487,409, filed on Feb. 28, 2023.

(51) Int. Cl. G02C 7/04; B29D 11/00; G02C 7/02; B29K 29/00

(52) U.S. Cl. CPC G02C 7/049; B29D 11/00057; B29D 11/00317; B29D 11/0048; G02C 7/021; B29C 2795/007; B29K 2029/04

(57) ABSTRACT

An embedded contact lens that comprises a lens body that has an anterior surface and an opposite posterior surface. The lens body is composed of a bulk hydrogel material and a circular insert embedded in the bulk hydrogel material and comprises an annular mask on the anterior surface or the posterior surface of the lens body. The circular insert comprises a peripheral edge. Both the annular mask and the insert are concentric with a central axis of the lens body. The annular mask is an opaque colored area that covers or overlaps the peripheral edge of the circular insert to minimize or eliminate optical disturbances induced by peripheral edge of the circular insert.

This application claims the benefits under 35 USC § 119 (e) of U.S. provisional application No. 63/487,409, filed on 28 Feb. 2023, incorporated by reference in its entirety.

### TECHNICAL FIELD

The present invention relates generally to the field of contact lenses, and more particularly to color mask for embedded contact lenses each having a diffractive optical insert embedded therein. cl BACKGROUND

Presbyopia is a well-known disorder in which the eye loses its ability to focus at close distance, affecting more than 2 billion patients worldwide. Extensive research efforts have been contributed to develop multifocal ophthalmic lenses (intraocular lenses or contact lenses) for correcting presbyopia. One of extensive research areas is the development of multifocal diffractive ophthalmic lenses. See, for example, U.S. Pat. Nos. 4,210,391, 4,338,005, 4,340,283, 4,637,697, 4,641,934, 4,642,112, 4,655,565, 4,830,481, 4,881,804, 4,881,805, 4,936,666, 4,995,714, 4,995,715, 5,054,905, 5,056,908, 5,076,684, 5,100,226, 5,104,212, 5,114,220, 5,116,111, 5,117,306, 5,120,120, 5,121,979, 5,121,980, 5,229,797, 5,748,282, 5,760,871, 5,982,543, 6,120,148, 6,364,483, 6,536,899, 6,951,391, 6,957,891, 7,025,456, 7,073,906, 7,093,938, 7,156,516, 7,188,949, 7,232,218, 7,891,810, 8,038,293, 8,128,222, 8,142,016, 8,382,281, 8,480,228, 8,556,416, 8,573,775, 8,678,583, 8,755,117, 9,033,494, 9,310,624, 9,320,594, 9,370,416, 10,197,815, 10,209,533, 10,426,599, 10,463,474, 10,524,899, 10,675,146, 10,725,320, 10,932,901, and 10,945,834. Currently, multifocal diffractive intraocular lenses are commercially available for correcting presbyopia.

However, multifocal diffractive contact lenses are still not commercially available for correcting presbyopia (see, Pérez-Prados, et al., “Soft Multifocal Simultaneous Image Contact Lenses: Review”, Clin. Exp. Optom. 2017, 100:107-127) probably due to some issues uniquely associated with contact lenses. For example, the standard lens materials have a refractive index of about 1.42 or less, i.e., about 0.04 higher than the refractive index of tear film. With such a small difference in refractive index, a higher diffraction grating height needs to be created on one of the anterior and posterior surfaces of a contact lens. But, contact lenses require smooth anterior and posterior surfaces for wearing comfort. Such a diffraction grating likely causes discomfort to a patient.

U.S. Pat. Appl. Pub. Nos. 2021/0191153 A1, 2021/0191154A1 and 2023/0004023A1 disclose contact lenses with an embedded diffractive optic insert therein for correction of presbyopia. The interface between a lens bulk material and the peripheral edge of a diffractive optical insert in such contact lenses can be a potential area for optical disturbances. For example, the angle of the peripheral edge of the embedded diffractive optical insert can affect optical distortion due to the significant difference in refractive index between the lens bulk material and the material of the embedded diffractive optical insert.

Accordingly, there exist needs for improvements to a contact lens with an embedded diffractive optical insert to reduce, control or eliminate optical disturbances induced by the peripheral edge of the diffractive optical insert.

### SUMMARY

The present invention provides improvements to embedded contact lenses each with an insert embedded therein, including reducing, controlling, or eliminating optical disturbances caused by the peripheral edges of the inserts without altering or modifying the shape or design of the peripheral edge of an insert. In particular embodiments, the present invention relates to masking the peripheral edge of the insert. Generally, a contact lens of the invention includes an anterior surface, an opposite posterior surface, a bulk hydrogel material, and an insert embedded in the bulk hydrogel material. The insert is made of a material having a refractive index higher than that of the bulk material. Due to the difference in refractive index between the bulk hydrogel material and the insert material, optical disturbances can occur in a region where a peripheral edge of the insert is in the embedded contact lens. Either the anterior surface or the posterior surface comprises an annular mask which is an opaque area that covers or overlaps the peripheral edge of the insert. The mask according to example embodiments of the present invention may help minimizing or eliminating optical disturbances induced by the peripheral edge of the insert within the user's field of vision, by for example at least partially obstructing and/or blocking light transmitted through the mask. Moreover, masking the peripheral edge of the insert using an annular mask on the anterior or posterior surface can alleviate the requirements for specific designs of the shapes or profiles of the peripheral edge of the insert, thereby providing greater freedom for other design considerations.

In one aspect, the present invention relates to an embedded contact lens that comprises a lens body that has an anterior surface and an opposite posterior surface, that is composed of a bulk hydrogel material and an insert embedded in the bulk hydrogel material, and that comprises an annular mask on the anterior surface or the posterior surface. The insert is made of a crosslinked polymeric material different from the bulk hydrogel material. The insert is circular and has a convex surface, an opposite concave surface, and a peripheral edge. Both the annular mask and the insert are concentric with a central axis of the lens body. The annular mask is an opaque colored area that covers or overlaps the peripheral edge of the insert to minimize or eliminate optical disturbances induced by peripheral edge of the insert.

In another aspect, the invention relates to a method of producing an embedded contact lens of the invention.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 is a cross-sectional view of an embedded contact lens according to an example embodiment of the present invention.

FIG. 2 is a plan view of the embedded contact lens of FIG. 1.

FIG. 3 is a cross-sectional view of an embedded contact lens according to another example embodiment of the present invention.

FIG. 4 is a cross-sectional view of an embedded contact lens according to yet another example embodiment of the present invention.

FIG. 5 is a cross-sectional view of an embedded contact lens according to yet another example embodiment of the present invention.

FIG. 6 shows an annular mask according to an example embodiment of the present invention.

FIG. 7 shows an annular mask according to yet another example embodiment of the present invention.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,”“an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. Also, any use of the terms “about,”“approximately,”“substantially,” and/or “generally” are intended to mean the exact value or characteristic indicated, as well as close approximations that are understood by persons of ordinary skill in the art to be sufficiently close to the exact value or characteristic based on the context of the intended use and application. In addition, any methods described herein are not intended to be limited to the sequence of steps described but can be carried out in other sequences, unless expressly stated otherwise herein.

“About” as used herein in this application means that a number, which is referred to as “about”, comprises the recited number plus or minus 1-10% of that recited number.

A “hydrogel” or “hydrogel material” refers to a crosslinked polymeric material which has three-dimensional polymer networks (i.e., polymer matrix), is insoluble in water, but can hold at least 10% by weight of water in its polymer matrix when it is fully hydrated (or equilibrated). A hydrogel material can be a non-silicone hydrogel material or a silicone hydrogel material.

A “non-silicone hydrogel” or “non-silicone hydrogel material” refers to a hydrogel material that is theoretically free of silicone.

A “silicone hydrogel,”“SiHy,”“silicone hydrogel material,” or “SiHy maerial” refers to a silicone-containing hydrogel obtained by copolymerization of a polymerizable composition comprising at least one silicone-containing monomer or at least one silicone-containing macromer or at least one crosslinkable silicone-containing prepolymer.

A siloxane, which often also described as a silicone, refers to a molecule having at least one moiety of —Si—O—Si— where each Si atom carries two organic groups as substituents.

As used in this application, the term “non-silicone hydrogel” or “non-silicone hydrogel material” interchangeably refers to a hydrogel that is theoretically free of silicon.

An “insert” refers to any 3-dimensional article which has a dimension of at least 5 microns but is smaller in dimension sufficient to be embedded in the bulk material of an embedded hydrogel contact lens and which is made of a material (preferably a non-hydrogel material) that is different from the bulk hydrogel material.

In accordance with the invention, a non-hydrogel material can be any material that can absorb less than 5% (preferably about 4% or less, more preferably about 3% or less, even more preferably about 2% or less) by weight of water when being fully hydrated.

In accordance with the invention, an insert of the invention has a thickness less than any thickness of an embedded hydrogel contact lens in the region where the insert is embedded. An insert can be any object have any geometrical shape and can have any desired functions.

The term “anterior surface”, “front surface”, “front curve surface” or “FC surface” in reference to a contact lens or an insert, as used in this application, interchangeably means a surface of the contact lens or insert that faces away from the eye during wear. The anterior surface (FC surface) is convex.

The “posterior surface”, “back surface”, “base curve surface” or “BC surface” in reference to a contact lens or insert, as used in this application, interchangeably means a surface of the contact lens or insert that faces towards the eye during wear. The posterior surface (BC surface) is concave.

A “central axis” in reference to a contact lens or lens body, as used in this application, means a imaginary reference line passing through the geometrical centers of the anterior and posterior surfaces of a contact lens or a lens body.

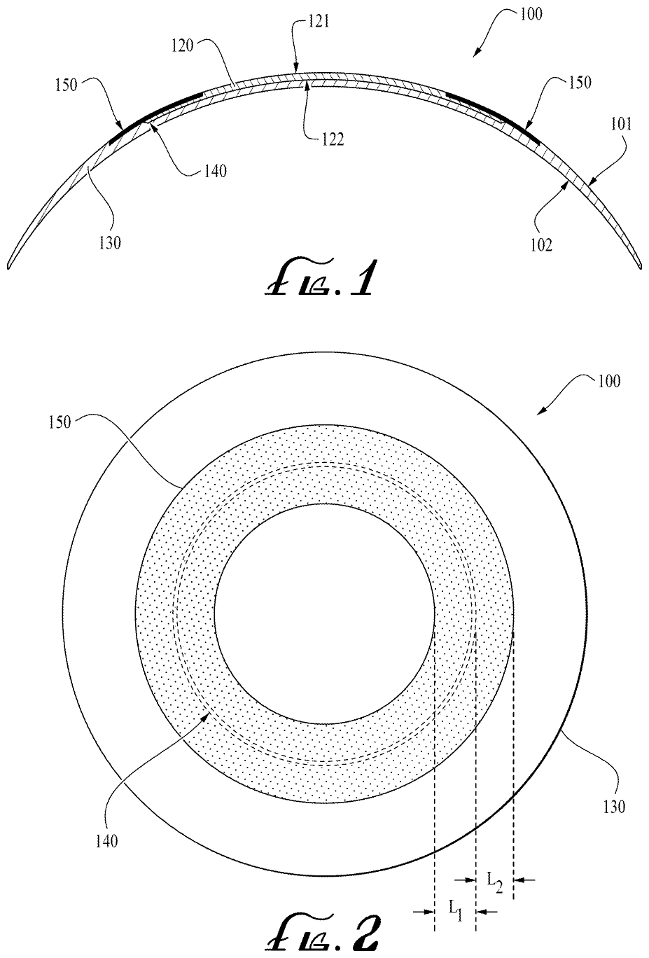

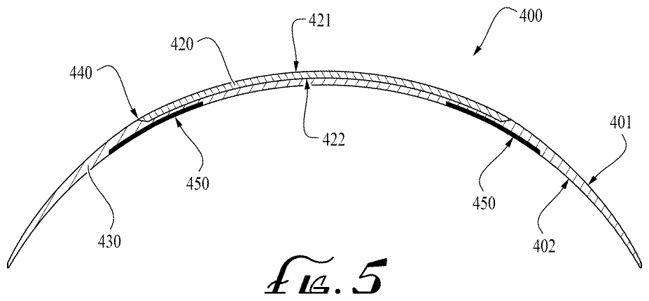

With reference now to the drawing figures, wherein like reference numbers represent corresponding parts throughout the several views, FIG. 1 shows a cross-sectional view of the lens body 100 of an embedded contact lens according to an example embodiment of the present invention. The lens body 100 has an anterior surface (front surface) 101 and an opposite posterior surface (back surface) 102. The lens body is composed of a bulk hydrogel material 130 and an insert 120 embedded in the bulk hydrogel material. In example embodiments, the insert 120 and the lens body 100 are generally circular, and the insert 120 is generally located in a central portion of the lens body 100 and concentric with the central axis of the lens body 100. The insert 120 is made of a crosslinked polymeric material having a refractive index higher than the refractive index of the bulk hydrogel material 130. The insert 120 has a convex surface 121 and an opposite concave surface 122. In some example embodiments, the convex surface 121 (421) of the insert merges with the anterior surface 101 (401) of the lens body while the concave surface 122 (422) of the insert 120 (420) is buried in the lens body (i.e., in direct contact with the bulk hydrogel material 130 (430)), for example as shown in FIGS. 1 and 5. In other example embodiments, the concave surface 222 (322) of the insert 220 (320) may merge with the posterior surface 202 (302) of the lens body 200 (300), for example as shown in FIGS. 3 and 4.

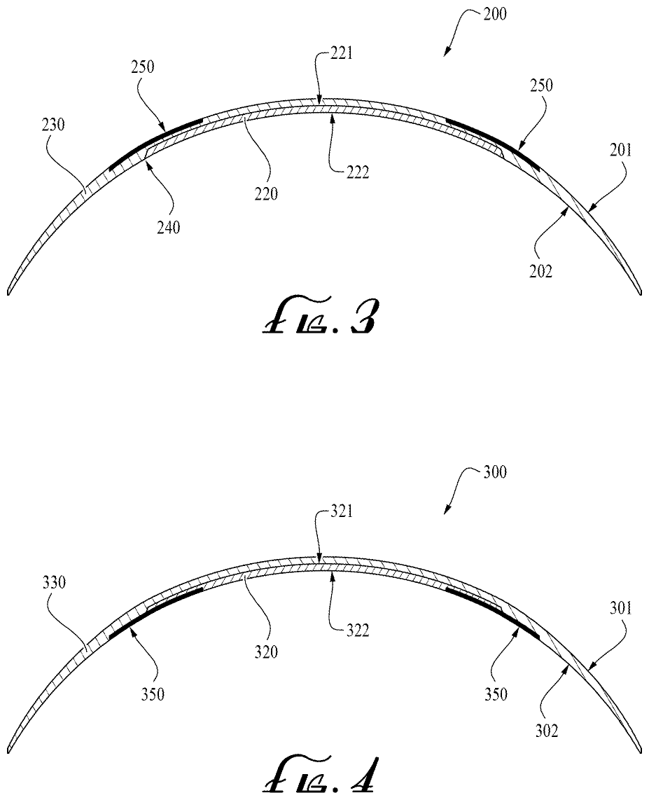

Depending upon the thickness of the insert 120 and the geometry of the outer periphery of the insert, the peripheral edge of the insert 120 may have a tapering surface 140 extending between an outer diameter or periphery (for example depicted as the outer circle in broken line in FIG. 2) and an inner diameter or periphery (for example depicted as the inner circle in broken line in FIG. 2) spanning a width-wise or radial distance at different depths within the lens body. In particular example embodiments, the diameter of the lens body 100 (i.e., measured at the edge of the lens body 100) may be between 12.5 mm to 15.5 mm, for example about 14 mm; and the diameter of the insert 120 (i.e., measured at the edge of the insert 120) may be between 5 mm to 12.5 mm, for example about 7 mm. In example embodiments, the insert 120 is formed of a crosslinked polymeric material having a first refractive index, and the bulk hydrogel material (a non-silicone hydrogel material or preferably a silicone hydrogel material) is different from the crosslinked polymeric material of the insert 120 and has a second refractive index different from the first refractive index. In example embodiments, the differential between the first refractive index and the second refractive index is at least about 0.05. In some example embodiments, the insert 120 may comprise a diffractive optical element formed of a relatively harder material having a relatively higher diffractive index, and the bulk hydrogel material 130 may comprise a relatively softer material having a relatively lower diffractive index. In alternate embodiments, the material selections for the bulk hydrogel material and insert material may be reversed. In further example embodiments, one or more additional layers, coatings, optical elements of the same or different materials may be provided on the lens body 100.

Any suitable insert materials and any suitable bulk hydrogel material can be used in the present invention. Examples of preferred insert materials and bulk hydrogel materials include without limitation those materials disclosed in U.S. Pat. Appl. Pub. Nos. 2022/0324187 A1, 2022/0326412 A1, 2022/0306810 A1, and 2023/0004023 A1, all of which are incorporated by references in their entireties.

In various preferred embodiments, the insert is made of a crosslinked polymeric material having a first refractive index, wherein the bulk hydrogel material is a silicone hydrogel material having a second refractive index, wherein the first refractive index is at least 0.05 (preferably at least 0.07, more preferably at least 0.09, even more preferably at least 0.10) higher than the second refractive index.

In those preferred embodiments, the crosslinked polymeric material of the insert has a refractive index of at least about 1.47, preferably at least about 1.49, more preferably at least about 1.51, even more preferably at least about 1.53. Optionally but preferably, the crosslinked polymeric material of the insert has an oxygen permeability of at least about 40 barrers, preferably at least about 60 barrers, more preferably at least about 80 barrers, even more preferably at least about 100 barrers. Such preferred insert materials are described in U.S. Pat. Appl. Pub. No. 2023/0004023 A1 (incorporated by reference in its entirety).

In accordance with the invention, the bulk hydrogel material is a non-silicone hydrogel material having a water content of from about 10% to about 70% by weight when being fully hydrated. A non-silicone hydrogel material can be formed from a non-silicone hydrogel lens formulation (i.e., a polymerizable composition) as known to a person skilled in the art. Typically, a non-silicone hydrogel lens formulation is either (1) a monomer mixture comprising (a) at least one hydrophilic vinylic monomer (e.g., hydroxyethyl methacrylate, glycerol methacrylate, N-vinylpyrrolidone, or combinations thereof) and (b) at least one component selected from the group consisting of a crosslinking agent, a hydrophobic vinylic monomer, a lubricating agent (or so-called internal wetting agents incorporated in a lens formulation), a free-radical initiator (photoinitiator or thermal initiator), a UV-absorbing vinylic monomer, a high-energy-violet-light (“HEVL”) absorbing vinylic monomer, a visibility tinting agent (e.g., reactive dyes, polymerizable dyes, pigments, or mixtures thereof), antimicrobial agents (e.g., preferably silver nanoparticles), a bioactive agent, and combinations thereof; or (2) an aqueous solution comprising one or more water-soluble prepolymers and at least one component selected from the group consisting of hydrophilic vinylic monomer, a crosslinking agent, a hydrophobic vinylic monomer, a lubricating agent (or so-called internal wetting agents incorporated in a lens formulation), a free-radical initiator (photoinitiator or thermal initiator), a UV-absorbing vinylic monomer, a HEVL absorbing vinylic monomer, a visibility tinting agent (e.g., reactive dyes, polymerizable dyes, pigments, or mixtures thereof), antimicrobial agents (e.g., preferably silver nanoparticles), a bioactive agent, and combinations thereof. Resultant preformed hydrogel contact lenses then can be subjected to extraction with an extraction solvent to remove unpolymerized components from the resultant lenses and to hydration process, as known by a person skilled in the art. It is understood that a lubricating agent present in a hydrogel lens formulation can improve the lubricity of preformed hydrogel contact lenses compared to the lubricity of control preformed hydrogel contact lenses obtained from a control hydrogel lens formulation without the lubricating agent.

Preferred examples of water-soluble prepolymers include without limitation: a water-soluble crosslinkable poly (vinyl alcohol) prepolymer described in U.S. Pat. Nos. 5,583,163 and 6,303,687 (both of which are incorporated by references in their entireties).

Numerous non-silicone hydrogel lens formulations have been described in numerous patents and patent applications published by the filing date of this application and have been used in producing commercial non-silicone hydrogel contact lenses. Examples of commercial non-silicone hydrogel contact lenses include, without limitation, alfafilcon A, acofilcon A, deltafilcon A, etafilcon A, focofilcon A, helfilcon A, helfilcon B, hilafilcon B, hioxifilcon A, hioxifilcon B, hioxifilcon D, methafilcon A, methafilcon B, nelfilcon A, nesofilcon A, ocufilcon A, ocufilcon B, ocufilcon C, ocufilcon D, omafilcon A, phemfilcon A, polymacon, samfilcon A, telfilcon A, tetrafilcon A, and vifilcon A.

In a preferred embodiment, the bulk hydrogel material is a non-silicone hydrogel material which comprises at least 50% by mole of repeating units of at least one hydroxyl-containing vinylic monomer, preferably selected from the group consisting of hydroxyethyl (meth)acrylate, glycerol (meth)acrylate, 3-hydroxypropyl (meth)acrylate, 2-hydroxypropyl (meth)acrylate, 3-amino-2-hydroxypropyl (meth)acrylate, N-2-hydroxyethyl (meth)acrylamide, N-3-hydroxypropyl (meth)acrylamide, N-2-hydroxypropyl (meth)acrylamide, N-2,3-dihydroxypropyl (meth)acrylamide, N-tris(hydroxymethyl) methyl (meth)acrylamide, vinyl alcohol, allyl alcohol, and combinations thereof, more preferably selected from the group consisting of hydroxyethyl (meth)acrylate, glycerol (meth)acrylate, and vinyl alcohol. The mole percentages of repeating units can be calculated based on a non-silicone hydrogel lens formulation for making the non-silicone hydrogel contact lens.

In another preferred embodiment, the bulk hydrogel material is a silicone hydrogel material that has an equilibrium water content (i.e., in fully hydrated state or when being fully hydrated) of from about 20% to about 70% (preferably from about 20% to about 65%, more preferably from about 25% to about 65%, even more preferably from about 30% to about 60%) by weight, an oxygen permeability of at least about 40 barrers (preferably at least about 60 barrers, more preferably at least about 80 barrers, more preferably at least about 100 barrers), and a modulus (i.e., Young's modulus) of about 1.5 MPa or less (preferably from about 0.2 MPa to about 1.2 MPa, more preferably from about 0.3 MPa to about 1.1 MPa, even more preferably from about 0.4 MPa to about 1.0 MPa). Such preferred bulk hydrogel materials (i.e., silicone hydrogel materials) are described in U.S Pat. Appl. Pub. No. 2023/0004023 A1 (incorporated by reference in its entirety).

Numerous SiHy lens formulations have been described in numerous patents and patent applications published by the filing date of this application and have been used in producing commercial SiHy contact lenses. Examples of commercial SiHy contact lenses include, without limitation, asmofilcon A, balafilcon A, comfilcon A, delefilcon A, efrofilcon A, enfilcon A, fanfilcon

A, galyfilcon A, lotrafilcon A, lotrafilcon B, narafilcon A, narafilcon B, senofilcon A, senofilcon B, senofilcon C, smafilcon A, somofilcon A, and stenfilcon A.

In example embodiments, the lens body 100 further includes a mask 150 on the anterior surface 101. The mask 150 is generally an opaque colored and/or pigmented area configured to mask or cover the tapering surface 140 of the peripheral edge of the insert 120 and the area around the tapering surface 140. Generally, the mask region has an annular or ring-like shape or profile and is concentric with the insert 120. In example embodiments, the mask 150 is configured to help block or obstruct (at least partially) the transmission of light through the mask 150 to the eye. The obstruction of light transmitted through the mask 150 minimizes the optical disturbances induced by the tapering surface 140 and/or optical distortions caused at the tapering surface 140. As shown in FIG. 2, the mask 150 generally has an annular shape or profile and follows the profile of the tapering surface 140. In other words, for example, the mask 150 comprises a buffer zone on both sides of the tapering surface 140 and thereby overlaps or covers at least portions of both the insert 120 and areas radially extending from the insert 120. In some example embodiments, for example, the radius of the outer radial edge of the mask 150 may be between about 0.1 mm to 1.0 mm greater than the radius of the tapering surface 140 (referring to reference character L₂ in FIG. 2), or preferably about 0.5 mm greater than the radius of the tapering surface 140, and the radius of the inner radial edge of the mask 150 may be between about 0.1 mm to 1.0 mm less than the radius of the tapering surface 140 (referring to reference character L₁ in FIG. 2), or preferably about 0.5 mm less than the radius of the tapering surface. In other example embodiments, L₁ may be greater than L₂. In alternate embodiments, L₂ may be greater than L₁. In yet another example embodiment, the mask 150 may be configured to cover only the area where the tapering surface 140 of the peripheral edge of the insert is located (i.e., the area between the two circles in broken lines). In preferred embodiments, the difference between the outer radius and the inner radius of the mask 150 is between about 0.2 mm and 2.0 mm, or more preferably about 1 mm. Moreover, in example embodiments, the width of the mask is dependent on the size of the peripheral edge—for example, a wider peripheral edge requiring a wider mask.

The annular mask 150 can have a substantially even outer radial edge and either a substantially even inner radial edge or an uneven or jagged inner radial edge. In some example embodiments, the annular mask 150 may have an uneven or jagged outer radial edge and either a substantially even inner radial edge or an uneven or jagged inner radial edge.

A “substantially even radial edge” as used herein refers to a radial edge on which positions have substantially constant radial distances (i.e., from the central axis of a lens body), namely differing from each other less than 20%. An “uneven or jagged radial edge” as used herein refers to a radial edge on which positions have radial distances (i.e., from the central axis of a lens body) which differ from each other by at least about 20%.

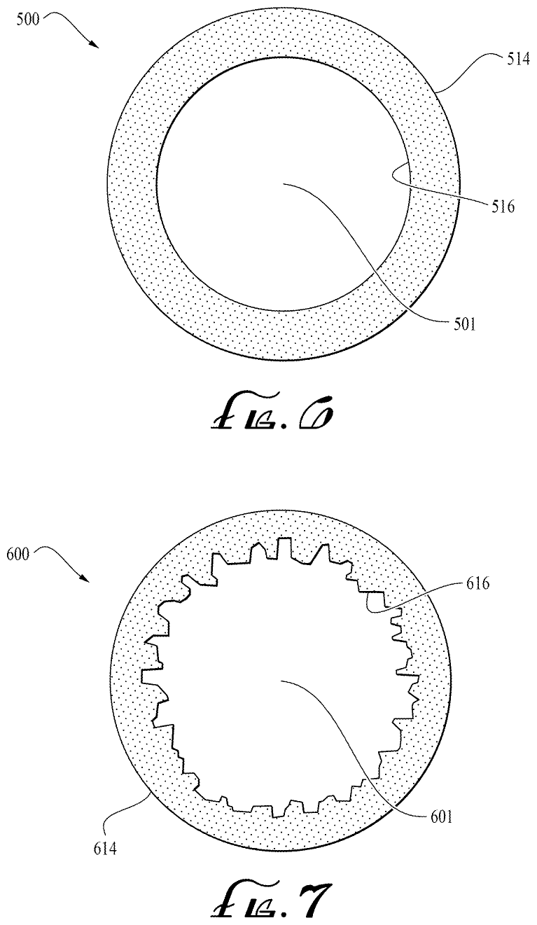

FIG. 6 illustrates schematically a preferred shape of an annular mask 500, which is an annular ring and is concentric with the central axis 501 of a lens body and has a substantially even outer radial edge 514 and a substantially even inner radial edge 516.

FIG. 7 illustrates schematically another preferred shape of an annular mask 600, which is an annular ring and is concentric with the central axis 601 of a lens body and has a substantially even outer radial edge 614 and an uneven or jagged inner radial edge 616.

The annular mask can be an opaque colored image with one single color or multi colors and having a shape of an annular ring. The opaque colored image can comprise one or more rings placed on top of each other to provide masking effects and also cosmetic effects (e.g., matching a wearer's eye color, modifying a wearer's eye color, making a wearer's eye bigger, etc.). Examples of such color images are disclosed in U.S. Pat. No. 9,039,173 (herein incorporated by reference in its entirety.

FIG. 1 shows an embedded contact lens with the insert embedded in an manner where the convex surface of the insert merges with the anterior surface of the lens body. However, the insert may also be embedded in a way that the concave surface of the insert merges with the posterior surface of the lens body, as shown in FIGS. 3 and 4. According to example embodiments of the present invention, the mask may be provided or introduced on either surfaces of the lens body of the embedded contact lens without regard to the configuration of the insert in the embedded contact lens. For example, FIG. 1 shows an embedded contact lens 100 with the insert 120 embedded on the anterior surface side of the lens body. In the depicted embodiment, the mask 150 is provided or introduced on the anterior surface of the lens body 100 (however, the mask 150 may be provided on the posterior surface of the lens body). FIG. 3 shows an embedded contact lens 200, according to another example embodiment, with an insert 220 embedded on the posterior surface side of the lens body, and a mask 250 provided on the anterior surface of the lens body. FIG. 4 shows an embedded contact lens 300, according to yet another example embodiment, with an insert 320 embedded on the posterior surface side of the lens body, and a mask 350 provided on the posterior surface of the lens body.

An embedded contact lens of the invention can be obtained by applying an ink directly onto a preformed embedded contact lens with an insert embedded therein according to any known method. A preferred method for applying an ink onto a preformed embedded contact lens with an insert embedded therein in accordance with this invention is through printing, for example, pad-transfer printing and/or inkjet printing using an ink, preferably a water-based ink.

An ink typically comprises pigment particles, a binder polymer, and a solvent as known to a person skilled in the art. An ink can optionally include a crosslinker, a humectant, a surfactant, a monomer, a polymerization initiator, an antimicrobial agent, an antioxidant agent, an anti-kogating agent, and other additives known in the art.

A solvent can be water (water-based inks) or any appropriate organic solvent (organic solvent-based inks). Any known suitable solvents can be used, so long as they can dissolve the binder in the ink of the invention and aid in the stability of the colorant. Examples of preferred solvents include water, or water mixed with one or more co-solvent. Alternately, organic solvents such as alcohols, glycols, ketones, esters, methyl ethyl ketone, cyclopentanone, and cyclohexanone could be used.

“A binder polymer” refers to a crosslinkable polymer that comprises crosslinkable groups and can be crosslinked by a crosslinker or upon initiation by a chemical or physical means (e.g., moisture, heating, UV irradiation or the like) to trap or bind colorants onto or into a contact lens such as that term is known in the art.

The term crosslinkable groups is employed herein in a broad sense and is intended to encompass, for example, functional groups and photo crosslinkable or thermally crosslinkable groups, which are well-known to a person skilled in the art. It is well known in the art that a pair of matching crosslinkable groups can form a covalent bond or linkage under known reaction conditions, such as, oxidation-reduction conditions, dehydration condensation conditions, addition conditions, substitution (or displacement) conditions, free radical polymerization conditions, 2+2 cyclo-addition conditions, Diels-Alder reaction conditions, ROMP (Ring Opening Metathesis Polymerization) conditions, vulcanization conditions, cationic crosslinking conditions, and epoxy hardening conditions. For example, an amino group is covalently bondable with aldehyde (Schiff base which is formed from aldehyde group and amino group may further be reduced); an hydroxyl group and an amino group are covalently bondable with carboxyl group; carboxyl group and a sulfo group are covalently bondable with hydroxyl group; a mercapto group is covalently bondable with amino group; or a carbon-carbon double bond is covalently bondable with another carbon-carbon double bond.

Exemplary covalent bonds or linkage, which are formed between pairs of crosslinkable groups, include without limitation, alkane (carbon-carbon single bond), alkene (carbon-carbon double bond), ester, ether, acetal, ketal, vinyl ether, carbamate, urea, amine, amide, enamine, imine, oxime, amidine, iminoester, carbonate, orthoester, phosphonate, phosphinate, sulfonate, sulfinate, sulfide, sulfate, disulfide, sulfinamide, sulfonamide, thioester, aryl, silane, siloxane, heterocycles, thiocarbonate, thiocarbamate, and phosphonamide.

Exemplary crosslinkable groups include, without limitation, hydroxyl group, amine group, amide group, sulfhydryl group, —COOR (R and R′ are hydrogen or C1 to C8 alkyl groups), halide (chloride, bromide, iodide), acyl chloride, isothiocyanate, isocyanate, monochlorotriazine, dichlorotriazine, mono-or di-halogen substituted pyridine, mono-or di-halogen substituted diazine, phosphoramidite, maleimide, aziridine, sulfonyl halide, hydroxysuccinimide ester, hydroxysulfosuccinimide ester, imido ester, hydrazine, axidonitrophenyl group, azide, 3-(2-pyridyl dithio) proprionamide, glyoxal, aldehyde, epoxy, olefinically unsaturated radicals.

A binder polymer in the ink can be any polymer which is compatible with lens material. A binder polymer can be prepared by polymerization of monomers containing vinyl alcohol, vinyl butyral, vinyl acetate, acrylic acid, methacrylic acid, hydroxy C₁to C₆ alkyl ester of acrylic acid and methacrylic acid, amino C₁to C₈ alkyl ester of acrylic and methacrylic acid, glycerol esters of acrylic and methacrylic acid, vinylpyrrolidone, vinylchloride, hydroxyethyl methacrylate, dimethylacrylamide, and the like. Mixtures of these different monomers could be made to form various copolymers. Other polymers could include various cellulosic resins, polyesters, polyurethanes, polyureas, or polyamides that have at least one crosslinkable group.

Preferably, monomers used in preparing a binding polymer is the same as that for monomers used in making a lens.

Pad transfer printing is well known in the art (see. For example, U.S. Pat. Nos. 3,536,386; 4,582,402; 4,704,017; 5,034,166, herein incorporated by reference in their entireties). A typical example of this printing follows. An image is etched into metal to form a cliché. The cliché is placed in a printer. Once in the printer, the cliché is inked by either an open inkwell doctoring system or by a closed ink cup sliding across the image. Then, a silicone pad picks up the inked image from the cliché and transfers the image to the contact lens. The silicone pads are made of a material comprising silicone that can vary in elasticity. The properties of the silicone material permit the inks to stick to the pad temporarily and fully release from the pad when it contacts a contact lens or a mold. Appropriate pad-transfer printing structures include, but are not limited to, Tampo-type printing structures (Tampo vario 90/130), rubber stamps, thimbles, doctor's blade, direct printing, or transfer printing as they are known in the art.

Any known suitable silicone pad can be used in the present invention. Silicone pads are commercially available. However, different pads could give different print qualities. A person skilled in the art will know how to select a pad for a given ink.

Clichés can be made of ceramics or metals (e.g., steel). Where a cliché is made of a steel, it would be desirable to neutralize the pH of a water-based ink (e.g., adjusted pH to 6.8˜7.8) by adding a buffer (such as, for example, phosphate salts). Images can be etched into a cliché according to any methods known to a person skilled in the art, for example, by chemical etching or laser ablation or the like. It is also desirable to clean clichés after use using standard cleaning techniques known to a person skilled in the art, such as, for example, immersion in a solvent, sonication, or mechanical abrasion.

It is understood that either the anterior (convex) or posterior (concave) surfaces of the lens may be printed, but printing the anterior surface is presently preferred to obtain an annular mask.

Printing the lens using an inkjet printing process is described in U.S. Pat. Appl. Nos. 2001/0050753, 2001/0085934, 2003/0119943, and 2003/0184710, herein incorporated by references in their entireties.

A preformed embedded contact lens can be obtained according to methods disclosed in U.S. Pat. No. 2022/0324187 A1 (herein incorporated by reference in its entirety).

As a first illustrative example, an embedded contact lens of the invention can be obtained according to the following procedures: (1) obtaining a female mold half, a first male mold half and a second male mold half, wherein the female mold half has a first molding surface defining the anterior surface of a contact lens to be molded, wherein the first male mold half has a second molding surface defining the back surface of an insert to be molded, wherein the second male mold half has a third molding surface defining the posterior surface of the contact lens to be molded, wherein the first male mold half and the female mold half are configured to receive each other such that an insert-molding cavity is formed between the second molding surface and a central portion of the first molding surface when the female mold half is closed with the first male mold half, wherein the second male mold half and the female mold half are configured to receive each other such that a lens-molding cavity is formed between the first and third molding surfaces when the female mold half is closed with the second male mold half; (2) dispensing an amount of an insert-forming composition on the central portion of the first molding surface of the female mold half; (3) placing the first male mold half on top of the insert-forming composition in the female mold half and closing the first male mold half and the female mold half to form a first molding assembly comprising the insert-forming composition within the insert-molding cavity; (4) curing the insert-forming composition in the insert-molding cavity of the first molding assembly to form a molded insert; (5) separating the first molding assembly obtained in step (4) into the first male mold half and the female mold half with the molded insert that is adhered onto the central area of the first molding surface; (6) dispensing a lens-forming composition in the female mold half with the molded insert adhered thereon in an amount sufficient for filling the lens-molding cavity; (7) placing the second male mold half on top of the lens-forming composition in the female mold half and closing the second male mold half and the female mold half to form a second molding assembly comprising the lens-forming composition and the molded insert immersed therein in the lens-molding cavity; (8) curing the lens-forming composition in the lens-molding cavity of the second molding assembly to form an embedded contact lens precursor that comprises a bulk hydrogel material formed from the lens-forming composition and the insert embedded in the bulk hydrogel material; (9) separating the second molding assembly obtained in step (8) into the second male mold half and the female mold half, with the embedded contact lens precursor adhered on a lens-adhered mold half which is one of the female and second male mold halves; (10) applying an ink to form an annular mask on exposed surface of the embedded contact lens precursor adhered on a lens-adhered mold half; (11) removing the embedded contact lens precursor obtained in step 10) from the lens-adhered mold half; and (11) subjecting the embedded contact lens precursor to post-molding processes including a hydration process and one or more other processes selected from the group consisting of extraction, surface treatment, packaging, sterilization, and combinations thereof, to obtain an embedded contact lens of the invention.

As a second illustrative example, an embedded contact lens of the invention can be obtained according to the following procedures: (1) obtaining a first female mold half, a male mold half and a second female mold half, wherein the first female mold half has a first molding surface defining the front surface of an insert to be molded, wherein the male mold half has a second molding surface defining the posterior surface of a contact lens to be molded, wherein the second female mold half has a third molding surface defining the anterior surface of the contact lens to be molded, wherein the first female mold half and the male mold half are configured to receive each other such that an insert-molding cavity is formed between the first molding surface and a central portion of the second molding surface when the first female mold half is closed with the male mold half, wherein the second female mold half and the male mold half are configured to receive each other such that a lens-molding cavity is formed between the second and third molding surfaces when the second female mold half is closed with the male mold half; (2) dispensing an amount of an insert-forming composition on the first molding surface of the first female mold half; (3) placing the male mold half on top of the insert-forming composition in the first female mold half and closing the first female mold half and the male mold half to form a first molding assembly comprising the insert-forming composition within the insert-molding cavity; (4) curing the insert-forming composition in the insert-molding cavity of the first molding assembly to form a molded insert; (5) separating the first molding assembly obtained in step (4) into the first female mold half and the male mold half with the molded insert that is adhered onto the central portion of the second molding surface; (6) dispensing a lens-forming composition in the second female mold half in an amount sufficient for filling the lens-molding cavity; (7) placing the male mold half with the molded insert adhered thereon on top of the lens-forming composition in the second female mold half and closing the second female mold half and the male mold half to form a second molding assembly comprising the lens-forming composition and the molded insert immersed therein in the lens-molding cavity; (8) curing the lens-forming composition in the lens-molding cavity of the second molding assembly to form an embedded contact lens precursor that comprises a bulk hydrogel material formed from the lens-forming composition and the insert completely or partially embedded in the bulk hydrogel material; (9) separating the second molding assembly obtained in step (8) into the second female mold half and the male mold half, with the embedded contact lens precursor adhered on a lens-adhered mold half which is one of the male and second female mold halves; (10) applying an ink to form an annular mask on exposed surface of the embedded contact lens precursor adhered on a lens-adhered mold half; (11) removing the embedded contact lens precursor obtained in step 10) from the lens-adhered mold half; and (11) subjecting the embedded contact lens precursor to post-molding processes including a hydration process and one or more other processes selected from the group consisting of extraction, surface treatment, packaging, sterilization, and combinations thereof to obtain an embedded contact lens of the invention.

Mold halves for making contact lenses (or inserts) are well known to a person skilled in the art and, for example, are employed in cast molding. In general, a molding assembly comprises at least two mold halves, one male half and one female mold half. The male mold half has a first molding (or optical) surface which is in direct contact with a polymerizable composition for cast molding of a contact lens (or an insert) and defines the posterior (back) surface of a molded contact lens (or a molded insert); and the female mold half has a second molding (or optical) surface which is in direct contact with the polymerizable composition and defines the anterior (front) surface of the molded contact lens (or molded insert). The male and female mold halves are configured to receive each other such that a lens-or insert-forming cavity is formed between the first molding surface and the second molding surface.

In a preferred embodiment, the mold half having a molding surface defining one of the anterior (front) and posterior (back) surfaces of the insert comprise an overflow groove which surrounds the molding surface and receives any excess insert-forming material when the molding assembly is closed. By having such an overflow groove, one can ensure that any flushes formed from the excess insert-forming material during molding of the insert can be stuck on the mold half having a molding surface defining the anterior (front) or posterior (back) surface of the insert during the step of separating the molding assembly halves, thereby removing the flushes.

Methods of manufacturing mold halves for cast-molding a contact lens or an insert are generally well known to those of ordinary skill in the art. The process of the present invention is not limited to any particular method of forming a mold half. In fact, any method of forming a mold half can be used in the present invention. The mold halves can be formed through various techniques, such as injection molding or lathing. Examples of suitable processes for forming the mold halves are disclosed in U.S. Pat. Nos. 4,444,711; 4,460,534; 5,843,346; and 5,894,002 (herein incorporated by reference in their entireties).

Virtually all materials known in the art for making mold halves can be used to make mold halves for making contact lenses or inserts. For example, polymeric materials, such as polyethylene, polypropylene, polystyrene, PMMA, Topas® COC grade 8007-S10 (clear amorphous copolymer of ethylene and norbornene, from Ticona GmbH of Frankfurt, Germany and Summit, New Jersey), or the like can be used.

In accordance with the invention, an insert-forming composition and a lens-forming composition are polymerizable compositions that are different from each other. They can differ from each other in the presence or absence of one or more polymerizable components, in the amounts of one or more polymerizable components, and/or in the presence or absence of one or more non-leachable additives for providing different optical properties (e.g., photochromic dyes or pigments, UV-absorbing materials, HEVL-absorbing materials, fluorescent dyes or pigments, color-filtering materials for correcting color blindness, diffractive materials, high refractive-index materials, etc.).

Any polymerizable compositions can be used as insert-forming composition in this application. Examples of preferred insert-forming compositions include without limitation those disclosed in U.S. pat. Appli. Pub. Nos. 2022/0324187 A1 (herein incorporated by reference in its entirety).

Any polymerizable compositions for forming hydrogel materials can be used as lens-forming composition.

In a preferred embodiment, the lens-forming composition is a non-silicone hydrogel lens-forming composition (or non-silicone hydrogel lens formulation) which is either (1) a monomer mixture comprising (a) at least one hydrophilic vinylic monomer (e.g., hydroxyl-containing vinylic monomer, N-vinylpyrrolidone, or combinations thereof) and (b) at least one component selected from the group consisting of a crosslinking agent, a hydrophobic vinylic monomer, a free-radical initiator (photoinitiator or thermal initiator), a UV-absorbing vinylic monomer, a high-energy-violet-light (“HEVL”) absorbing vinylic monomer, a visibility tinting agent, and combinations thereof; or (2) an aqueous solution comprising one or more water-soluble prepolymers and at least one component selected from the group consisting of hydrophilic vinylic monomer, a crosslinking agent, a hydrophobic vinylic monomer, a lubricating agent (or so-called internal wetting agents incorporated in a lens formulation), a free-radical initiator (photoinitiator or thermal initiator), a UV-absorbing vinylic monomer, a HEVL absorbing vinylic monomer, a visibility tinting agent, and combinations thereof.

Numerous non-silicone hydrogel lens formulations have been described in numerous patents and patent applications published by the filing date of this application and have been used in producing commercial non-silicone hydrogel contact lenses. Examples of commercial non-silicone hydrogel contact lenses include, without limitation, alfafilcon A, acofilcon A, deltafilcon A, etafilcon A, focofilcon A, helfilcon A, helfilcon B, hilafilcon B, hioxifilcon A, hioxifilcon B, hioxifilcon D, methafilcon A, methafilcon B, nelfilcon A, nesofilcon A, ocufilcon A, ocufilcon B, ocufilcon C, ocufilcon D, omafilcon A, phemfilcon A, polymacon, samfilcon A, telfilcon A, tetrafilcon A, and vifilcon A. They can be used as a lens-forming composition of the invention.

Preferably, non-silicone hydrogel lens-forming composition comprises at least 50% by mole of at least one hydroxyl-containing vinylic monomer, preferably selected from the group consisting of hydroxyethyl (meth)acrylate, glycerol (meth)acrylate, 3-hydroxypropyl (meth)acrylate, 2-hydroxypropyl (meth)acrylate, 3-amino-2-hydroxypropyl (meth)acrylate, N-2-hydroxyethyl (meth)acrylamide, N-3-hydroxypropyl (meth)acrylamide, N-2-hydroxypropyl (meth)acrylamide, N-2,3-dihydroxypropyl (meth)acrylamide, N-tris(hydroxymethyl) methyl (meth)acrylamide, vinyl alcohol, allyl alcohol, and combinations thereof, more preferably selected from the group consisting of hydroxyethyl (meth)acrylate, glycerol (meth)acrylate, and vinyl alcohol.

In another preferred embodiment, a lens-forming composition is a silicone hydrogel lens-forming composition (i.e. a silicone hydrogel lens formulation). Numerous silicone hydrogel lens formulations have been described in numerous patents and patent applications published by the filing date of this application and have been used in producing commercial SiHy contact lenses. Examples of commercial SiHy contact lenses include, without limitation, asmofilcon A, balafilcon A, comfilcon A, delefilcon A, efrofilcon A, enfilcon A, fanfilcon A, galyfilcon A, lotrafilcon A, lotrafilcon B, narafilcon A, narafilcon B, senofilcon A, senofilcon B, senofilcon C, smafilcon A, somofilcon A, and stenfilcon A. They can be used as a lens-forming composition of the invention. Examples of preferred silicone hydrogel lens-forming compositions include without limitation those disclosed in U.S. Pat. Appl. Pub. No. 2022/0324187 A1 (herein incorporated by reference in its entirety).

The insert-forming composition and the lens-forming composition can be introduced into the insert-molding cavity and the lens-molding cavity respectively according any techniques known to a person skilled in the art.

When the first molding assembly is closed, any excess insert-forming composition is pressed into an overflow groove provided on the insert mold half (i.e., the first male mold half having a second molding surface defining the posterior surface of an insert to be molded or the first female mold half having a first molding surface defining the anterior surface of an insert to be molded).

When the second molding assembly is closed, any excess lens-forming composition is pressed into an overflow groove provided on either one of the two mold halves each having a molding surface defining one of the anterior and posterior surfaces of a contact lens to be molded. The overflow groove surrounds the molding surface defining one of the anterior and posterior surfaces of a contact lens to be molded.

The curing of the insert-forming composition within the insert-molding cavity of the closed first molding assembly and the lens-forming composition within the lens-molding cavity of the closed second molding assembly can be carried out thermally (i.e., by heating) or actinically (i.e., by actinic radiation, e.g., UV radiation and/or visible radiation) to activate the polymerization initiators.

The actinic polymerization of the insert-or lens-forming composition in a molding assembly can be carried out by irradiating the closed molding assembly with the insert- or lens-forming composition therein with an UV or visible light, according to any techniques known to a person skilled in the art.

The thermal polymerization of the insert-or lens-forming composition in a molding assembly can be carried out conveniently in an oven at a temperature of from 25 to 120° C. and preferably 40 to 100° C., as well known to a person skilled in the art. The reaction time may vary within wide limits, but is conveniently, for example, from 1 to 24 hours or preferably from 2 to 12 hours. It is advantageous to previously degas the silicone-hydrogel-lens-forming composition and to carry out said copolymerization reaction under an inert atmosphere, e.g., under N₂ or Ar atmosphere.

The step of separating the first molding assembly can be carried out according to any techniques known to a person skilled in the art. It is understood that the molded insert is adhered onto the female mold having a molding defining the anterior surface of a contact lens to be molded (in one aspect) or onto the male mold have a molding surface defining the posterior surface of a contact lens to be molded (in another aspect). Many techniques are known in the art. For example, the molding surface of the mold half designed to adhere the molded insert can be surface-treated to render the molded insert preferentially adhered to the molding surface of this mold half. Alternatively, a compression force can be applied by using a mold-opening device to non-optical surface (opposite to the molding surface) of the mold half (not adhering the molded insert) of the first molding assembly at a location about the center area of non-optical molding surface at an angle of less than about 30 degrees, preferably less than about 10 degrees, most preferably less than about 5 degrees (i.e., in a direction substantially normal to center area of non-optical molding surface) relative to the axis of the mold to deform the mold half, thereby breaking bonds between the molding surface of the mold half and the molded insert. Various ways of applying a force to non-optical surface of the mold half at a location about the center area of non-optical molding surface along the axis of the mold to deform the mold half which breaks the bonds between the optical molding surface of the mold half and the molded insert. It is understood that the mold-opening device can have any configurations known to a person skilled in the art for performing the function of separating two mold halves from each other.

Similarly, the step of separating the second molding assembly can be carried out according to any techniques known to a person skilled in the art. It is understood that the molded embedded contact lens precursor can be adhered onto either one of the two mold halves of the second molding assembly.

An ink is applied on the unprocessed embedded contact lens adhered onto one of the two mold halves of the second molding assembly to form the annular mask on the exposed surface. Subsequently, the embedded contact lens precursor with the annular mask can be delensed (i.e., removed) from the lens-adhered mold half according to any techniques known to a person skilled in the art.

After delensing, it typically is extracted with an extraction medium as well known to a person skilled in the art. The extraction liquid medium is any solvent capable of dissolving the diluent(s), unpolymerized polymerizable materials, and oligomers in the embedded contact lens precursor. Water, any organic solvents known to a person skilled in the art, or a mixture thereof can be used in the invention. Preferably, the organic solvents used extraction liquid medium are water, a buffered saline, a C₁-C₃ alkyl alcohol, 1,2-propylene glycol, a polyethyleneglycol having a number average molecular weight of about 400 Daltons or less, a C₁-C₆ alkylalcohol, or combinations thereof.

The extracted embedded contact lens precursor can then be hydrated according to any method known to a person skilled in the art to form a bilayer contact lens of the invention.

The extracted embedded contact lens precursor can also subject to further processes, such as, for example, surface treatment, packaging in lens packages with a packaging solution which is well known to a person skilled in the art; sterilization such as autoclave at from 118 to 124° C. for at least about 30 minutes; and the like.

Lens packages (or containers) are well known to a person skilled in the art for autoclaving and storing a soft contact lens. Any lens packages can be used in the invention. Preferably, a lens package is a blister package which comprises a base and a cover, wherein the cover is detachably sealed to the base, wherein the base includes a cavity for receiving a sterile packaging solution and the contact lens.

Lenses are packaged in individual packages, sealed, and sterilized (e.g., by autoclave at about 120° C. or higher for at least 30 minutes under pressure) prior to dispensing to users. A person skilled in the art will understand well how to seal and sterilize lens packages.

Alternatively, an embedded contact lens of the invention can be obtained according to different processes similar to a print-on-mold process described in U.S. Pat. No. 5,034,166 (herein incorporated by reference).

For example, the above-described first process can be modified by removing step (10) and also adding, after step (6) but before step (7), one step of applying an ink on the molding surface of the second male mold half to form a colored coat (with a color image) in a shape of annular ring. Optionally but preferably, after printing an ink of the invention on a molding surface of a mold half, the printed ink can be cured by UV or other actinic radiation to form a colored film in accordance with the invention. It is desirable that the printed ink is cured actinically to an extent to minimize loss of pattern definition of the colored coat resulted from subsequent filling of a lens-forming composition in step (6). The colored coat or film will be detached from the molding surface and become integral part of the lens body of a molded embedded contact lens.

Similarly, the above-described second process can be modified by removing step (10) and also adding, after step (5) but before step (6), one step of applying an ink on the molding surface of the second female mold half to form a colored coat (with a color image) in a shape of annular ring. Optionally but preferably, after printing an ink of the invention on a molding surface of a mold half, the printed ink can be cured by UV or other actinic radiation to form a colored film in accordance with the invention. It is desirable that the printed ink is cured actinically to an extent to minimize loss of pattern definition of the colored coat resulted from subsequent steps (6) and (7). The colored coat or film will be detached from the molding surface and become integral part of the lens body of a molded embedded contact lens. In addition, it should be understood that aspects of the various embodiments of the invention may be interchanged either in whole or in part or can be combined in any manner and/or used together, e.g., the following embodiments as illustrated below:

1. An embedded contact lens comprising a lens body that has an anterior surface and an opposite posterior surface, that is composed of a bulk hydrogel material and an insert embedded in the bulk hydrogel material, and that comprises an annular mask on the anterior surface or the posterior surface, wherein the insert is made of a crosslinked polymeric material different from the bulk hydrogel material, wherein the insert is circular and has a convex surface, an opposite concave surface, and a peripheral edge, wherein both the annular mask and the insert are concentric with a central axis of the lens body, wherein the annular mask is an opaque colored area that covers or overlaps the peripheral edge of the insert so as to minimize or eliminate optical disturbances induced by the peripheral edge of the insert.

2. The embedded contact lens of embodiment 1, wherein the bulk hydrogel material is a non-silicone hydrogel material having a water content of from about 10% to about 70% by weight when being fully hydrated.

3. The embedded contact lens of embodiment 1, wherein the bulk hydrogel material is a non-silicone hydrogel material which has a water content of from about 10% to about 70% by weight or less in fully hydrated state and comprises at least 50% by mole of repeating units of at least one hydroxyl-containing vinylic monomer, preferably selected from the group consisting of hydroxyethyl (meth)acrylate, glycerol (meth)acrylate, 3-hydroxypropyl (meth)acrylate, 2-hydroxypropyl (meth)acrylate, 3-amino-2-hydroxypropyl (meth)acrylate, N-2-hydroxyethyl (meth)acrylamide, N-3-hydroxypropyl (meth)acrylamide, N-2-hydroxypropyl (meth)acrylamide, N-2,3-dihydroxypropyl (meth)acrylamide, N-tris(hydroxymethyl) methyl (meth)acrylamide, vinyl alcohol, allyl alcohol, and combinations thereof, more preferably selected from the group consisting of hydroxyethyl (meth)acrylate, glycerol (meth)acrylate, and vinyl alcohol.

4. The embedded contact lens of embodiment 1, wherein the bulk hydrogel material is a silicone hydrogel material that in fully hydrated has a water content of from about 10% to about 70% by weight or less and an oxygen permeability of at least about 50 barrers.

5. The embedded contact lens of embodiment 4, wherein the bulk hydrogel material in fully hydrated state has: a water content of from about 20% to about 70% (preferably from about 25% to about 65%, more preferably from about 30% to about 60%) by weight, an elastic modulus of from about 0.2 MPa to about 2.0 MPa (preferably from about 0.25 MPa to about 1.5 MPa, more preferably from about 0.3 MPa to about 1.2 MPa, even more preferably from about 0.35 MPa to about 1.0 MPa), an oxygen transmissibility of at least 60 barrers/mm (preferably at least 70 barrers/mm, more preferably at least 80 barrers/mm, even more preferably at least 100 barrers/mm), and an averaged water contact angle of less than 90 degrees (preferably less than 80 degrees, more preferably less than 70 degrees, even more preferably less than 60 degrees).

6. The embedded contact lens of any one of embodiments 1 to 5, wherein the crosslinked polymeric material has a first refractive index and the bulk hydrogel material has a second refractive index different from the first refractive index, wherein there is a difference of at least 0.05 (preferably at least 0.07, more preferably at least 0.09, even more preferably at least 0.10) between the first refractive and the second refractive index.

7. The embedded contact lens of any one of embodiments 1 to 5, wherein the crosslinked polymeric material has a first refractive index, and the bulk hydrogel material has a second refractive index different from the first refractive index, wherein the first refractive index is at least 0.05 (preferably at least 0.07, more preferably at least 0.09, even more preferably at least 0.10) higher than the second refractive index.

8. The embedded contact lens of embodiment 7, wherein the crosslinked polymeric material of the insert has a first refractive index of at least about 1.47 (preferably at least about 1.49, more preferably at least about 1.51, even more preferably at least about 1.53).

9. The embedded contact lens of embodiment 1, wherein the first material comprises a first material hardness and a first diffractive index and the second material comprises a second material hardness higher than the first material hardness and a second diffractive index higher than the first diffractive index.

10. The embedded contact lens of any one of embodiments 1 to 9, wherein the insert comprises a diffractive optical element.

11. The embedded contact lens of any one of embodiments 1 to 10, wherein the lens body has a diameter of from about 12.5 mm to about 15.5 mm.

12. The embedded contact lens of any one of embodiments 1 to 11, wherein the insert has a diameter of from about 5 mm to about 12.5 mm.

13. The embedded contact lens of any one of embodiments 1 to 12, wherein the anterior surface of the lens body comprises the annular mask.

14. The embedded contact lens of any one of embodiments 1 to 12, wherein the posterior surface of the lens body comprises the annular mask.

15. The embedded contact lens of any one of embodiments 1 to 14, wherein the annular mask has an outer radius between about 0.1 mm and 1.0 mm greater than the radius of the peripheral edge of the insert.

16. The embedded contact lens of any one of embodiment 1 to 14, wherein the annular mask has an inner radius between about 0.1 mm and 1.0 mm smaller than the radius of the peripheral edge of the insert.

17. The embedded contact lens of any one of embodiments 1 to 16, wherein difference between an outer radius and an inner radius of the annular mask is between about 0.2 mm and about 2.0 mm.

18. The embedded contact lens of any one of embodiments 1 to 17, wherein the annular mask has a substantially even outer radial edge and a substantially even or an uneven inner radial edge.

19. The embedded contact lens of any one of embodiments 1 to 18, wherein the insert is embedded such that the convex surface of the insert is merged with the anterior surface of the lens body.

20. The embedded contact lens of any one of embodiments 1 to 18, wherein the insert is embedded such that the concave surface of the insert is merged with the posterior surface of the lens body.

21. A method of producing an embedded contact lens with an annular mask, the method comprising the steps of:
obtaining a female mold half, a first male mold half, and a second male mold half, wherein the female mold half has a first molding surface defining an anterior surface of the embedded contact lens, wherein the first male mold half has a second molding surface defining a back surface of the insert to be molded, wherein the second male mold half has a third molding surface defining a posterior surface of the contact lens to be molded, wherein the first male mold half and the female mold half are configured to receive each other such that an insert-molding cavity is formed between the second molding surface and a central portion of the first molding surface when the female mold half is closed with the first male mold half, wherein the second male mold half and the female mold half are configured to receive each other such that a lens-molding cavity is formed between the first and third molding surfaces when the female mold half is closed with the second male mold half;
dispensing an amount of an insert-forming composition on the central portion of the first molding surface of the female mold half;
placing the first male mold half on top of the insert-forming composition in the female mold half and closing the first male mold half and the female mold half to form a first molding assembly comprising the insert-forming composition within the insert-molding cavity;
curing the insert-forming composition in the insert-molding cavity of the first molding assembly to form a molded insert;
separating the first molding assembly into the first male mold half and the female mold half with the molded insert that is adhered onto the central area of the first molding surface;
dispensing a lens-forming composition in the female mold half with the molded insert adhered thereon in an amount sufficient for filling the lens-molding cavity;
placing the second male mold half on top of the lens-forming composition in the female mold half and closing the second male mold half and the female mold half to form a second molding assembly comprising the lens-forming composition and the molded insert immersed therein in the lens-molding cavity;
curing the lens-forming composition in the lens-molding cavity of the second molding assembly to form an embedded contact lens precursor that comprises a bulk hydrogel material formed from the lens-forming composition and the insert embedded in the bulk hydrogel material;
separating the second molding assembly into the second male mold half and the female mold half with the embedded contact lens precursor adhered on a lens-adhered mold half which is one of the female and second male mold halves;
applying an ink to form the annular mask on an exposed surface of the embedded contact lens precursor adhered on the lens-adhered mold half, wherein the annular mask is an opaque colored area that covers or overlaps the peripheral edge of the insert so as to minimize or eliminate optical disturbances induced by the peripheral edge of the insert; and
removing the embedded contact lens precursor from the lens-adhered mold half.

22. The method of producing the embedded contact lens of embodiment 21, further comprising the step of subjecting the embedded contact lens precursor to post-molding processes including a hydration process and one or more other processes selected from the group consisting of extraction, surface treatment, packaging, sterilization, and combinations thereof.

23. The method of producing the embedded contact lens of embodiment 21 or 22, wherein the bulk hydrogel material is a non-silicone hydrogel material.

24. The method of producing the embedded contact lens of embodiment 21 or 22, wherein the bulk hydrogel material is a silicone hydrogel material.

25. A method of producing an embedded contact lens with an annular mask, the method comprising the steps of:
obtaining a first female mold half, a male mold half, and a second female mold half, wherein the first female mold half has a first molding surface defining a front surface of an insert to be molded, wherein the male mold half has a second molding surface defining a posterior surface of a contact lens to be molded, wherein the second female mold half has a third molding surface defining an anterior surface of the contact lens to be molded, wherein the first female mold half and the male mold half are configured to receive each other such that an insert-molding cavity is formed between the first molding surface and a central portion of the second molding surface when the first female mold half is closed with the male mold half, wherein the second female mold half and the male mold half are configured to receive each other such that a lens-molding cavity is formed between the second and third molding surfaces when the second female mold half is closed with the male mold half;
dispensing an amount of an insert-forming composition on the first molding surface of the first female mold half;
placing the male mold half on top of the insert-forming composition in the first female mold half and closing the first female mold half and the male mold half to form a first molding assembly comprising the insert-forming composition within the insert-molding cavity;
curing the insert-forming composition in the insert-molding cavity of the first molding assembly to form a molded insert;
separating the first molding assembly into the first female mold half and the male mold half with the molded insert that is adhered onto the central portion of the second molding surface;
dispensing a lens-forming composition in the second female mold half in an amount sufficient for filling the lens-molding cavity;
placing the male mold half with the molded insert adhered thereon on top of the lens-forming composition in the second female mold half and closing the second female mold half and the male mold half to form a second molding assembly comprising the lens-forming composition and the molded insert immersed therein in the lens-molding cavity;
curing the lens-forming composition in the lens-molding cavity of the second molding assembly to form an embedded contact lens precursor that comprises a bulk hydrogel material formed from the lens-forming composition and the insert completely or partially embedded in the bulk hydrogel material;
separating the second molding assembly into the second female mold half and the male mold half with the embedded contact lens precursor adhered on a lens-adhered mold half which is one of the male and second female mold halves;
applying an ink to form the mask on an exposed surface of the embedded contact lens precursor adhered on the lens-adhered mold half, wherein the annular mask is an opaque colored area that covers or overlaps the peripheral edge of the insert so as to minimize or eliminate optical disturbances induced by the peripheral edge of the insert; and
removing the embedded contact lens precursor from the lens-adhered mold half.

26. The method of producing the embedded contact lens of embodiment 25, further comprising the step of subjecting the embedded contact lens precursor to post-molding processes including a hydration process and one or more other processes selected from the group consisting of extraction, surface treatment, packaging, sterilization, and combinations thereof to obtain an embedded contact lens of the invention.

27. The method of producing the embedded contact lens of embodiment 25 or 26, wherein the bulk hydrogel material is a non-silicone hydrogel material.

28. The method of producing the embedded contact lens of embodiment 25 or 26, wherein the bulk hydrogel material is a non-silicone hydrogel material.

While the invention has been described with reference to example embodiments, it will be understood by those skilled in the art that a variety of modifications, additions and deletions are within the scope of the invention, as defined by the following claims.

What is claimed is:

1. An embedded contact lens comprising a lens body that has an anterior surface and an opposite posterior surface, that is composed of a bulk hydrogel material and an insert embedded in the bulk hydrogel material, and that comprises an annular mask on the anterior surface or the posterior surface, wherein the insert is made of a crosslinked polymeric material different from the bulk hydrogel material, wherein the insert is circular and has a convex surface, an opposite concave surface, and a peripheral edge, wherein both the annular mask and the insert are concentric with a central axis of the lens body, wherein the annular mask is an opaque colored area that covers or overlaps the peripheral edge of the insert so as to minimize or eliminate optical disturbances induced by the peripheral edge of the insert, wherein the bulk hydrogel material has a water content of from about 10% to about 70% by weight when being fully hydrated, wherein the lens body has a diameter of from about 12.5 mm to about 15.5 mm.

2. The embedded contact lens of claim 1, wherein the bulk hydrogel material is a non-silicone hydrogel material which comprises at least 50% by mole of repeating units of at least one hydroxyl-containing vinylic monomer.

3. The embedded contact lens of claim 1, wherein the bulk hydrogel material is a silicone hydrogel material and when being fully hydrated has: an oxygen permeability of at least about 50 barrers, an elastic modulus of from about 0.2 MPa to about 2.0 MPa, an oxygen transmissibility of at least 60 barrers/mm, and an averaged water contact angle of less than 90 degrees.

4. The embedded contact lens of claim 1, wherein the crosslinked polymeric material has a first refractive index and the bulk hydrogel material has a second refractive index different from the first refractive index, wherein the first refractive index is at least 0.05 (preferably at least 0.07, more preferably at least 0.09, even more preferably at least 0.10) higher than the second refractive index.

5. The embedded contact lens of claim 4, wherein the crosslinked polymeric material of the insert has a first refractive index of at least about 1.47 (preferably at least about 1.49, more preferably at least about 1.51, even more preferably at least about 1.53).

6. The embedded contact lens of claim 5, wherein the insert comprises a diffractive optical element.

7. The embedded contact lens of claim 6, wherein the insert has a diameter of from about 5 mm to about 12.5 mm.

8. The embedded contact lens of claim 7, wherein the anterior surface of the lens body comprises the annular mask.

9. The embedded contact lens of claim 7, wherein the posterior surface of the lens body comprises the annular mask.

10. The embedded contact lens of claim 7, wherein the annular mask has an outer radius between about 0.1 mm and 1.0 mm greater than the radius of the peripheral edge of the insert, wherein the annular mask has an inner radius between about 0.1 mm and 1.0 mm smaller than the radius of the peripheral edge of the insert.

11. The embedded contact lens of claim 10, wherein difference between an outer radius and an inner radius of the annular mask is between about 0.2 mm and about 2.0 mm, wherein the annular mask has a substantially even outer radial edge and a substantially even or an uneven inner radial edge.

12. The embedded contact lens of claim 11, wherein the insert is embedded such that the convex surface of the insert is merged with the anterior surface of the lens body.

13. The embedded contact lens of claim 11, wherein the insert is embedded such that the concave surface of the insert is merged with the posterior surface of the lens body.

14. A method of producing an embedded contact lens with an annular mask, the method comprising the steps of:
obtaining a female mold half, a first male mold half, and a second male mold half, wherein the female mold half has a first molding surface defining an anterior surface of the embedded contact lens, wherein the first male mold half has a second molding surface defining a back surface of the insert to be molded, wherein the second male mold half has a third molding surface defining a posterior surface of the contact lens to be molded, wherein the first male mold half and the female mold half are configured to receive each other such that an insert-molding cavity is formed between the second molding surface and a central portion of the first molding surface when the female mold half is closed with the first male mold half, wherein the second male mold half and the female mold half are configured to receive each other such that a lens-molding cavity is formed between the first and third molding surfaces when the female mold half is closed with the second male mold half;
dispensing an amount of an insert-forming composition on the central portion of the first molding surface of the female mold half;
placing the first male mold half on top of the insert-forming composition in the female mold half and closing the first male mold half and the female mold half to form a first molding assembly comprising the insert-forming composition within the insert-molding cavity;
curing the insert-forming composition in the insert-molding cavity of the first molding assembly to form a molded insert;
separating the first molding assembly into the first male mold half and the female mold half with the molded insert that is adhered onto the central area of the first molding surface;
dispensing a lens-forming composition in the female mold half with the molded insert adhered thereon in an amount sufficient for filling the lens-molding cavity;
placing the second male mold half on top of the lens-forming composition in the female mold half and closing the second male mold half and the female mold half to form a second molding assembly comprising the lens-forming composition and the molded insert immersed therein in the lens-molding cavity;
curing the lens-forming composition in the lens-molding cavity of the second molding assembly to form an embedded contact lens precursor that comprises a bulk hydrogel material formed from the lens-forming composition and the insert embedded in the bulk hydrogel material;
separating the second molding assembly into the second male mold half and the female mold half with the embedded contact lens precursor adhered on a lens-adhered mold half which is one of the female and second male mold halves;
applying an ink to form the annular mask on an exposed surface of the embedded contact lens precursor adhered on the lens-adhered mold half, wherein the annular mask is an opaque colored area that covers or overlaps the peripheral edge of the insert so as to minimize or eliminate optical disturbances induced by the peripheral edge of the insert;
removing the embedded contact lens precursor from the lens-adhered mold half; and
subjecting the embedded contact lens precursor to post-molding processes including a hydration process and one or more other processes selected from the group consisting of extraction, surface treatment, packaging, sterilization, and combinations thereof.

15. A method of producing an embedded contact lens with an annular mask, the method comprising the steps of:
obtaining a first female mold half, a male mold half, and a second female mold half, wherein the first female mold half has a first molding surface defining a front surface of an insert to be molded, wherein the male mold half has a second molding surface defining a posterior surface of a contact lens to be molded, wherein the second female mold half has a third molding surface defining an anterior surface of the contact lens to be molded, wherein the first female mold half and the male mold half are configured to receive each other such that an insert-molding cavity is formed between the first molding surface and a central portion of the second molding surface when the first female mold half is closed with the male mold half, wherein the second female mold half and the male mold half are configured to receive each other such that a lens-molding cavity is formed between the second and third molding surfaces when the second female mold half is closed with the male mold half;
dispensing an amount of an insert-forming composition on the first molding surface of the first female mold half;
placing the male mold half on top of the insert-forming composition in the first female mold half and closing the first female mold half and the male mold half to form a first molding assembly comprising the insert-forming composition within the insert-molding cavity;
curing the insert-forming composition in the insert-molding cavity of the first molding assembly to form a molded insert;
separating the first molding assembly into the first female mold half and the male mold half with the molded insert that is adhered onto the central portion of the second molding surface;
dispensing a lens-forming composition in the second female mold half in an amount sufficient for filling the lens-molding cavity;
placing the male mold half with the molded insert adhered thereon on top of the lens-forming composition in the second female mold half and closing the second female mold half and the male mold half to form a second molding assembly comprising the lens-forming composition and the molded insert immersed therein in the lens-molding cavity;
curing the lens-forming composition in the lens-molding cavity of the second molding assembly to form an embedded contact lens precursor that comprises a bulk hydrogel material formed from the lens-forming composition and the insert completely or partially embedded in the bulk hydrogel material;
separating the second molding assembly into the second female mold half and the male mold half with the embedded contact lens precursor adhered on a lens-adhered mold half which is one of the male and second female mold halves;
applying an ink to form the mask on an exposed surface of the embedded contact lens precursor adhered on the lens-adhered mold half, wherein the annular mask is an opaque colored area that covers or overlaps the peripheral edge of the insert so as to minimize or eliminate optical disturbances induced by the peripheral edge of the insert;
removing the embedded contact lens precursor from the lens-adhered mold half; and
subjecting the embedded contact lens precursor to post-molding processes including a hydration process and one or more other processes selected from the group consisting of extraction, surface treatment, packaging, sterilization, and combinations thereof to obtain an embedded contact lens of the invention.
